(19) United States
(12) Patent Application Publication
(10) Pub. No.: US 2026/0060883 A1
(43) Pub. Date: Mar. 5, 2026

(54) MALE GENITAL MASSAGE DEVICE

(71) Applicant: Wenzhou Xiaotaoqi Trading Co.,Ltd, Wenzhou (CN)

(72) Inventors: Hailun Zhu, Wenzhou (CN); Jianjian Zhou, Wenzhou (CN)

(21) Appl. No.: 19/386,285

(22) Filed: Nov. 12, 2025

(51) Int. Cl. A61H 19/00; A61H 23/02

(52) U.S. Cl. CPC A61H 19/32; A61H 23/0263; A61H 2201/0207; A61H 2201/0228; A61H 2201/1695

(57) ABSTRACT

The present disclosure discloses a male genital massage device, including a base; where an enclosing portion is arranged on the base, with an accommodation cavity formed therein; the enclosing portion is provided with at least two chambers corresponding to side walls of the accommodation cavity; and a functional component for heating and vibrating is arranged in each of the chambers; and a touch member is arranged on the base in a swing manner, and extends into the accommodation cavity. The device has a simple structure, can effectively massage a male genital for relaxation, is convenient to use, and has a good use effect.

### TECHNICAL FIELD

The present disclosure relates to a male genital massage device.

### BACKGROUND

With an accelerating pace of life, increasing work pressure, and changes in lifestyle structure and habits, many people are in a sub-healthy state. Therefore, young people nowadays have a particular preference for massage and relaxation. Some simple massage devices can effectively help relax both a body and a mind. These massage devices can reasonably simulate human physiological sensations and provide users with a safe and controllable way to relieve physiological needs. However, existing portable male genital massage devices have relatively rough functional structures. For example, in terms of a heating function, a heating solution commonly used in the industry now is “direct heating by an electric heating rod”, that is, a cylindrical electric heating element is directly embedded inside a device cavity for pre-heating. In this way, the heating uniformity is poor: an area around the electric heating rod is too hot, while an edge area, away from the electric heating rod, of the cavity fails to reach an adequate temperature, thereby forming an obvious temperature gradient and thus reducing user experience. Meanwhile, the structure has a single function, and relaxation massage can only be achieved through vibration, which affects a practical effect of the structure, is not conducive to product promotion, and impacts economic benefits of enterprises.

### SUMMARY

To address the deficiencies in the prior art, the present disclosure provides a male genital massage device. The male genital massage device features a simple structure, effective massage and relaxation functions, convenient use, and favorable use effect.

To achieve the above objectives, the present disclosure provides a male genital massage device, including a base, where an enclosing portion is arranged on the base; an accommodation cavity for accommodating a male genital is formed in the enclosing portion; at least two chambers are arranged on side walls of the enclosing portion corresponding to the accommodation cavity; and a functional component for heating and vibrating is arranged in each of the chambers.

The beneficial effects of this configuration are as follows: a user can place the genital into the accommodation cavity, and a layout of the functional components in the at least two chambers on the side walls of the enclosing portion breaks limitation of single-point action, and forms a full-coverage heating and vibration network, so as to solve the problem of local overheating or uneven vibration, keep a temperature of each area on the side walls of the accommodation cavity balanced, and make a vibration sensation more conformable to a contour of a contact surface. Dual massage effects of warm heat penetration and deep-tissue vibration are realized. Warm heat can pre-relax local muscles and promote circulation, laying a foundation for vibration massage, while vibration can act precisely on a contact part; and synergistic actions of the two upgrade massage experience from a superficial touch sensation to a deep and comfortable one. Meanwhile, a bionic shape of the accommodation cavity that fits the contour of the genital, combined with a natural wrapping sensation of a flexible material, can avoid rigid stimulation caused by mechanical contact and enhance safety and comfort during use. A design of embedding the functional components in the chambers not only prevents wear caused by direct contact with the outside, but also forms heat insulation and buffering through walls of the chambers, thereby reducing noise generated when vibration is transmitted to the base, and simplifying an assembly process. During subsequent maintenance, only the components inside the chambers need to be inspected and repaired, greatly improving durability and maintenance convenience of the device. Preferably, the functional components in the plurality of chambers can realize independent temperature control and frequency modulation to adapt to the somatosensory needs of different users.

As a further configuration of the present disclosure, the functional component includes a seat body, a vibration motor and an electric heating sheet; a positioning groove is formed in the seat body; the vibration motor is clamped in the positioning groove; a first housing is arranged on the seat body in a circumferential direction corresponding to the vibration motor; the electric heating sheet is wrapped around the first housing; a second housing is further arranged on the seat body outside the electric heating sheet; the electric heating sheet is in clearance fit with the second housing; a wiring hole is formed in a bottom surface of the seat body; and the electric heating sheet and the vibration motor are respectively electrically connected to a control circuit board in the base through the wiring hole.

The beneficial effects of this configuration are as follows: with this configuration, from a structural perspective, the positioning groove of the seat body directly limits a position of the vibration motor through snap-fit fixation, enabling accurate positioning of the motor without an additional fastener. Combined with the circumferential first housing, a dual-fixation structure is formed, to effectively prevent the motor from displacing or loosening due to high-frequency vibration during operation. A double-housing structure in which the electric heating sheet is wrapped around the first housing and the second housing is nested outside not only provides physical protection for the internal motor and the electric heating sheet, but also ensures a compact and neat overall structure through rigid support from the housings, thereby truly achieving simplicity of an “integrated configuration”, significantly reducing assembly difficulty and a plurality of parts, and balancing production efficiency and cost control. The first housing not only serves a fixing function, but also forms an isolation layer between the motor and the electric heating sheet, to prevent a damage to the electric heating sheet caused when the mechanical vibration of the vibration motor is directly transmitted to the electric heating sheet, and weaken the impact of a high temperature of the electric heating sheet on the service life of the motor. The clearance fit between the electric heating sheet and the second housing reserves a buffer space for thermal expansion of the electric heating sheet after heating, thereby preventing structural deformation caused by thermal stress and further improving structural stability during long-term use. Preferably, heat dissipation holes can also be formed in the circumferential direction of the chamber; meanwhile, through circuit control, the circuit can be cut off timely when the temperature in the chamber is too high. Such control technologies belong to the prior art and will not be elaborated herein.

As a further configuration of the present disclosure, a surrounding groove is formed in the first housing corresponding to the electric heating sheet, and the electric heating sheet is embedded in the surrounding groove.

The beneficial effects of this configuration are as follows: with this configuration, embedding cooperation between the surrounding groove of the first housing and the electric heating sheet can effectively restrict radial and axial displacement of the electric heating sheet in a vibration environment, so as to avoid loosening or displacement of the electric heating sheet caused by resonance generated by the high-frequency operation of the vibration motor, and significantly improve anti-vibration stability of the overall structure of the functional component. Through the embedding method, the electric heating sheet fits more closely with the first housing, resulting in more uniform force distribution and reducing a risk of a damage to the electric heating sheet caused by local stress concentration. In addition, the surrounding groove can also provide circumferential support for the electric heating sheet and form multiple fixations together with the outer second housing, thereby indirectly improving uniformity of heat conduction, simplifying a positioning process during assembly, and reducing an installation error rate.

As a further configuration of the present disclosure, the enclosing portion is made of a flexible material, and an insertion opening for placing the functional component into the chamber is formed in the accommodation cavity of the enclosing portion.

The beneficial effects of this configuration are as follows: with this configuration, a design of the insertion opening allows disassembly and assembly of the functional component without disassembling the enclosing portion, thereby not only protecting integrity of the flexible material and avoiding cracking or deformation caused by repeated disassembly, but also simplifying a replacement and maintenance process of the functional component. In addition, elasticity of the flexible material can adapt to vibration transmission of the functional component, making the vibration sensation more uniform and gentler.

As a further configuration of the present disclosure, a touch member is arranged on the base in a swing manner, and extends into the accommodation cavity.

The beneficial effects of this configuration are as follows: with this configuration, the swing design of the touch member further enriches the experience level. Its dynamic extending action can simulate a bionic touch sensation, to form a combined dynamic and static touch sensation with static heating and vibration of the functional component, and avoid monotony of a single massage mode. The touch member extending into the accommodation cavity can form a dynamic gentle touch on a sensitive area, to form a combined dynamic and static touch sensation with static vibration and heating of the cavity wall, and avoid the monotony of the single massage mode. Moreover, a swing amplitude is adapted to a physiological sensitivity threshold, which cannot only provide comfortable experience, but also maintain vitality of a reproductive system through moderate stimulation.

As a further configuration of the present disclosure, the touch member includes a touch plate and a touch motor; the touch plate is arranged on the base in the swing manner, one end of the touch plate extends into the accommodation cavity and is covered with a soft pad, and the other end is provided with a driving groove; the touch motor is arranged in the base; and an eccentric column is eccentrically arranged on an output end of the touch motor, and is arranged in the driving groove.

The beneficial effects of this configuration are as follows: with this configuration, the touch motor converts circular motion to reciprocating swing of the touch plate through rotation of the eccentric column in the driving groove. This transmission method has no rigid hard connection, can make a swing action natural and soft, and can accurately simulate a gentle rhythm of real touch. An end of the touch plate extending into the accommodation cavity is covered with the soft pad, and provides a delicate and skin-friendly touch during contact together with the flexible enclosing portion, to avoid discomfort caused by hard contact. The soft pad can be made of a breathable and skin-friendly material to improve contact safety. A structure of the soft pad closely resembles that of a human tongue, to simulate a licking feeling. By adjusting eccentricity of the eccentric column, the swing amplitude of the touch plate can be flexibly adjusted to adapt to different usage needs, forming a multi-dimensional touch synergy with heating and vibration of the functional component.

As a further configuration of the present disclosure, the enclosing portion is provided with a boss in the accommodation cavity corresponding to the functional component, and kneading protrusions are uniformly distributed on the boss.

The beneficial effects of this configuration are as follows: with this configuration, the boss is arranged in the accommodation cavity corresponding to the functional component and can concentrate vibration energy of the functional component and transmit to the contact area, thereby avoiding force attenuation caused by vibration dispersion, and making a vibration massage effect more focused and significant. The kneading protrusions uniformly distributed on the boss can form multi-point contact. During vibration, the kneading protrusions simulate a touch sensation similar to finger pad kneading through elastic deformation of the protrusions. Compared with planar contact, this design improves layering and three-dimensionality of massage.

As a further configuration of the present disclosure, the accommodation cavity is provided with a plurality of soft protrusions in a circumferential direction of the boss.

The beneficial effects of this configuration are as follows: with this configuration, when the boss undertakes a main vibration massage function, the circumferential soft protrusions can absorb the diffused vibration energy through their own elastic deformation, thereby forming a gentle auxiliary massage touch sensation, filling a touch blind area around the boss, and avoiding a disjointed feeling caused by excessively strong intensity in local areas and insufficient intensity in peripheral areas during the massage experience. An elastic property of the soft protrusions enables them to adapt to a contour of the contact part, and ensures a fitting touch at different angles.

As a further configuration of the present disclosure, the enclosing portion is provided with a lip at an opening of the accommodation cavity.

The beneficial effects of this configuration are as follows: with this configuration, the enclosing portion is made of the flexible material and is provided with the lip, to naturally fit a curve of the human contact part and provide a delicate and warm touch sensation, and avoid discomfort of friction caused by a hard material. Combined with the heating function of the functional component, a temperature and soft texture of human skin can be accurately simulated, and a sense of realism and comfort during use are dramatically enhanced.

### BRIEF DESCRIPTION OF THE DRAWINGS

FIG. 1 is a structural schematic diagram of an embodiment of the present disclosure;

FIG. 2 is a structural schematic diagram of an upper base of an embodiment of the present disclosure;

FIG. 3 is a side view of an upper base of an embodiment of the present disclosure; and

FIG. 4 is a cross-sectional view of a functional component of an embodiment of the present disclosure.

### DETAILED DESCRIPTION OF THE EMBODIMENTS

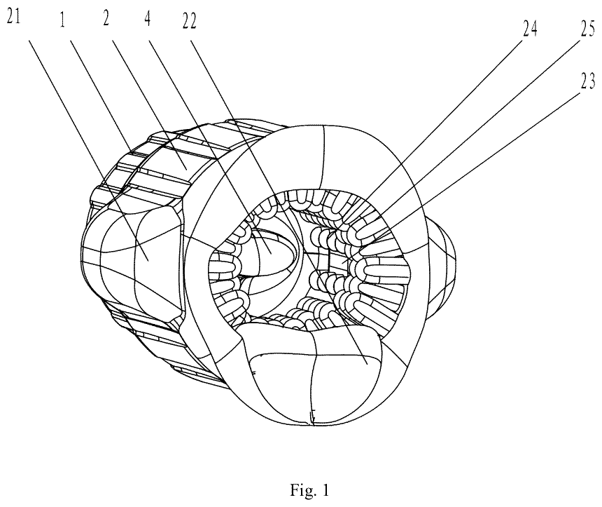

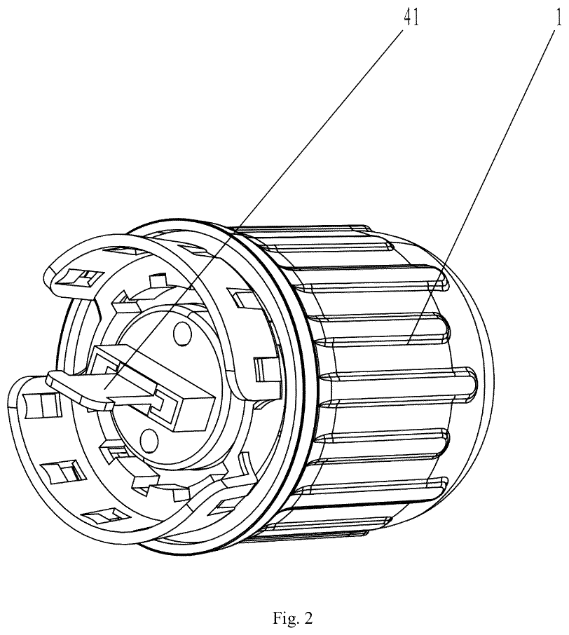

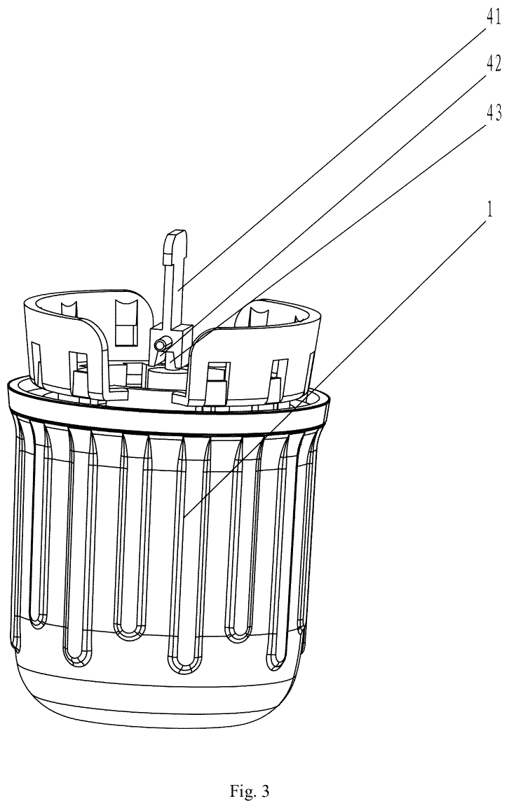

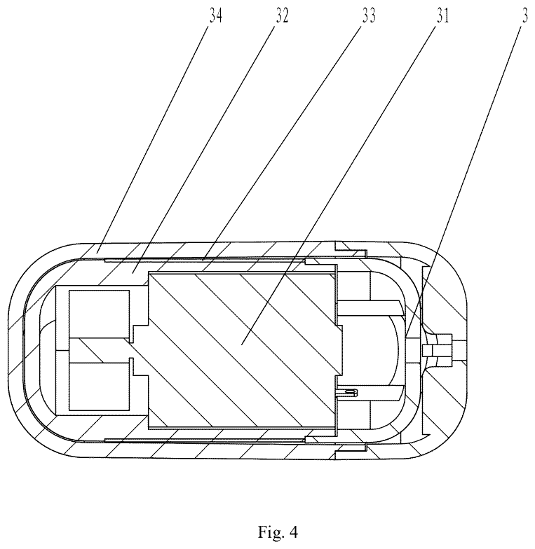

The present disclosure provides an embodiment of a male genital massage device. As shown in FIGS. 1 to 4, the male genital massage device includes a base 1, where an enclosing portion 2 is arranged on the base 1, with an accommodation cavity formed therein; at least two chambers 21 are arranged on side walls of the enclosing portion 2 corresponding to the accommodation cavity; a functional component for heating and vibrating is arranged in each of the chambers 21; and a touch member 4 is arranged on the base 1 in a swing manner, and extends into the accommodation cavity. The beneficial effects of this configuration are as follows: a user can place a genital into the accommodation cavity, and a layout of the functional components in at least two chambers 21 on the side walls of the enclosing portion 2 breaks limitation of single-point action, and forms a full-coverage heating and vibration network, so as to solve the problem of local overheating or uneven vibration, keep a temperature of each area on the side walls of the accommodation cavity balanced, and make a vibration sensation more conformable to a contour of a contact surface. Dual massage effects of warm heat penetration and deep-tissue vibration are realized. Warm heat can pre-relax local muscles and promote circulation, laying a foundation for vibration massage, while vibration can act precisely on a contact part; and synergistic actions of the two upgrade massage experience from a superficial touch sensation to a deep and comfortable one. A design of embedding the functional components in the chambers 21 not only prevents wear caused by direct contact with the outside, but also forms heat insulation and buffering through walls of the chambers 21, thereby reducing noise generated when vibration is transmitted to the base 1, and simplifying an assembly process. During subsequent maintenance, only the components inside the chambers 21 need to be inspected and repaired, greatly improving durability and maintenance convenience of the device. A swing design of the touch member 4 further enriches the experience level. Its dynamic extending action can simulate a bionic touch sensation, to form a combined dynamic and static touch sensation with static heating and vibration of the functional component, and avoid monotony of a single massage mode. Preferably, the functional components in the plurality of chambers 21 can realize independent temperature control and frequency modulation to adapt to the somatosensory needs of different users.

As a further configuration of this implementation, the functional component includes a seat body 3, a vibration motor 31 and an electric heating sheet 33; a positioning groove is formed in the seat body 3; the vibration motor 31 is clamped in the positioning groove; a first housing 32 is arranged on the seat body 3 in a circumferential direction corresponding to the vibration motor 31; the electric heating sheet 33 is wrapped around the first housing 32; a second housing 34 is further arranged on the seat body 3 outside the electric heating sheet 33; the electric heating sheet 33 is in clearance fit with the second housing 34; a wiring hole is formed in a bottom surface of the seat body 3; and the electric heating sheet 33 and the vibration motor 31 are respectively electrically connected to a control circuit board in the base 1 through the wiring hole. The beneficial effects of this configuration are as follows: with this configuration, from a structural perspective, the positioning groove of the seat body 3 directly limits a position of the vibration motor 31 through snap-fit fixation, enabling accurate positioning of the motor without an additional fastener. Combined with the circumferential first housing 32, a dual-fixation structure is formed, to effectively prevent the motor from displacing or loosening due to high-frequency vibration during operation. A double-housing structure in which the electric heating sheet 33 is wrapped around the first housing 32 and the second housing 34 is nested outside not only provides physical protection for the internal motor and the electric heating sheet 33, but also ensures a compact and neat overall structure through the rigid support from the housings, thereby truly achieving simplicity of an “integrated configuration”, significantly reducing assembly difficulty and a plurality of parts, and balancing production efficiency and cost control. The first housing 32 not only serves a fixing function but also forms an isolation layer between the motor and the electric heating sheet 33, to prevent a damage to the electric heating sheet 33 caused when mechanical vibration of the vibration motor 31 is directly transmitted to the electric heating sheet 33, and weaken the impact of a high temperature of the electric heating sheet 33 on the service life of the motor. The clearance fit between the electric heating sheet 33 and the second housing 34 reserves a buffer space for thermal expansion of the electric heating sheet 33 after heating, thereby preventing structural deformation caused by thermal stress and further improving structural stability during long-term use. Preferably, heat dissipation holes can also be formed in the circumferential direction of the chamber; meanwhile, through circuit control, the circuit can be cut off timely when a temperature in the chamber is too high. Such control technologies belong to the prior art and will not be elaborated herein.

As a further configuration of this implementation, a surrounding groove is formed in the first housing 32 corresponding to the electric heating sheet 33, and the electric heating sheet 33 is embedded in the surrounding groove. The beneficial effects of this configuration are as follows: with this configuration, embedding cooperation between the surrounding groove of the first housing 32 and the electric heating sheet 33 can effectively restrict radial and axial displacement of the electric heating sheet 33 in a vibration environment, so as to avoid loosening or displacement of the electric heating sheet 33 caused by resonance generated by high-frequency operation of the vibration motor 31, and significantly improve anti-vibration stability of the overall structure of the functional component. Through the embedding method, the electric heating sheet 33 fits more closely with the first housing 32, resulting in more uniform force distribution and reducing a risk of a damage to the electric heating sheet 33 caused by local stress concentration. In addition, the surrounding groove can also provide circumferential support for the electric heating sheet 33 and form multiple fixations together with the outer second housing 34, thereby indirectly improving uniformity of heat conduction, simplifying a positioning process during assembly, and reducing an installation error rate.

As a further configuration of this implementation, the enclosing portion 2 is made of a flexible material, and an insertion opening for placing the functional component into the chamber 21 is formed in the accommodation cavity of the enclosing portion 2. The beneficial effects of this configuration are as follows: with this configuration, a design of the insertion opening allows disassembly and assembly of the functional component without disassembling the enclosing portion 2, thereby not only protecting integrity of the flexible material and avoiding cracking or deformation caused by repeated disassembly, but also simplifying a replacement and maintenance process of the functional component. In addition, elasticity of the flexible material can adapt to vibration transmission of the functional component, making a vibration sensation more uniform and gentler.

As a further configuration of this implementation, the touch member 4 includes a touch plate 41 and a touch motor; the touch plate 41 is arranged on the base 1 in the swing manner; one end of the touch plate 41 extends into the accommodation cavity and is covered with a soft pad, and the other end is provided with a driving groove 42; the touch motor is arranged in the base 1; and an eccentric column 43 is eccentrically arranged on an output end of the touch motor, and is arranged in the driving groove 42. The beneficial effects of this configuration are as follows: with this configuration, the touch motor converts circular motion to reciprocating swing of the touch plate 41 through rotation of the eccentric column 43 in the driving groove 42. This transmission method has no rigid hard connection, can make a swing action natural and soft, and can accurately simulate a gentle rhythm of real touch. An end of the touch plate 41 extending into the accommodation cavity is covered with the soft pad, and provides a delicate and skin-friendly touch during contact together with the flexible enclosing portion 2, to avoid discomfort caused by hard contact. The soft pad can be made of a breathable and skin-friendly material to improve contact safety. By adjusting eccentricity of the eccentric column 43, a swing amplitude of the touch plate 41 can be flexibly adjusted to adapt to different usage needs, forming a multi-dimensional tactile synergy with heating and vibration functions of the functional component.

As a further configuration of this implementation, the enclosing portion 2 is provided with a boss 23 in the accommodation cavity corresponding to the functional component, and kneading protrusions 24 are uniformly distributed on the boss 23. The beneficial effects of this configuration are as follows: with this configuration, the boss 23 is arranged in the accommodation cavity corresponding to the functional component and can concentrate vibration energy of the functional component and transmit to the contact area, thereby avoiding force attenuation caused by vibration dispersion, and making a vibration massage effect more focused and significant. The kneading protrusions 24 uniformly distributed on the boss 23 can form multi-point contact. During vibration, the kneading protrusions simulate a touch sensation similar to finger pad kneading through elastic deformation of the protrusions. Compared with planar contact, this design improves layering and three-dimensionality of massage.

As a further configuration of this implementation, the accommodation cavity is provided with a plurality of soft protrusions 25 in a circumferential direction of the boss 23. The beneficial effects of this configuration are as follows: with this configuration, when the boss 23 undertakes a main vibration massage function, the circumferential soft protrusions 25 can absorb diffused vibration energy through their own elastic deformation, thereby forming a gentle auxiliary massage touch sensation, filling a touch blind area around the boss 23, and avoiding a disjointed feeling caused by excessively strong intensity in local areas and insufficient intensity in peripheral areas during the massage experience. An elastic property of the soft protrusions 25 enables them to adapt to a contour of the contact part, and ensures a fitting touch at different angles.

As a further configuration of this implementation, the enclosing portion 2 is provided with a lip 22 at an opening of the accommodation cavity. The beneficial effects of this configuration are as follows: with this configuration, the enclosing portion 2 is made of the flexible material and is provided with the lip 22, to naturally fit a curve of a human contact part and provide a delicate and warm touch sensation, and avoid discomfort of friction caused by a hard material. Combined with a heating function of the functional component, a temperature and soft texture of human skin can be accurately simulated, and a sense of realism and comfort during use are dramatically enhanced.

The above example is merely one of the preferred specific examples of the present disclosure. All routine changes and substitutions made by those skilled in the art within the scope of the technical solution of the present disclosure shall be included in the protection scope of the present disclosure.

What is claimed is:

1. A male genital massage device, comprising a base, wherein an enclosing portion is arranged on the base, and an accommodation cavity for accommodating a male genital is formed in the enclosing portion; and wherein at least two chambers are arranged on side walls of the enclosing portion corresponding to the accommodation cavity, and a functional component for heating and vibrating is arranged in each of the chambers.

2. The male genital massage device according to claim 1, wherein the functional component comprises a seat body, a vibration motor and an electric heating sheet; a positioning groove is formed in the seat body; the vibration motor is clamped in the positioning groove; a first housing is arranged on the seat body in a circumferential direction corresponding to the vibration motor; the electric heating sheet is wrapped around the first housing; a second housing is further arranged on the seat body outside the electric heating sheet; the electric heating sheet is in clearance fit with the second housing; a wiring hole is formed in a bottom surface of the seat body; and the electric heating sheet and the vibration motor are respectively electrically connected to a control circuit board in the base through the wiring hole.

3. The male genital massage device according to claim 2, wherein a surrounding groove is formed in the first housing corresponding to the electric heating sheet, and the electric heating sheet is embedded in the surrounding groove.

4. The male genital massage device according to claim 2, wherein the enclosing portion is made of a flexible material, and an insertion opening for placing the functional component into the chamber is formed in the accommodation cavity of the enclosing portion.

5. The male genital massage device according to claim 1, wherein a touch member is arranged on the base in a swing manner, and extends into the accommodation cavity.

6. The male genital massage device according to claim 5, wherein the touch member comprises a touch plate and a touch motor; the touch plate is arranged on the base in the swing manner, one end of the touch plate extends into the accommodation cavity and is covered with a soft pad, and the other end is provided with a driving groove; the touch motor is arranged in the base; and an eccentric column is eccentrically arranged on an output end of the touch motor, and is arranged in the driving groove.

7. The male genital massage device according to claim 1, wherein the enclosing portion is provided with a boss in the accommodation cavity corresponding to the functional component, and kneading protrusions are uniformly distributed on the boss.

8. The male genital massage device according to claim 7, wherein the accommodation cavity is provided with a plurality of soft protrusions in a circumferential direction of the boss.

9. The male genital massage device according to claim 1, wherein the enclosing portion is provided with a lip at an opening of the accommodation cavity.
